(19) United States
(12) Patent Application Publication
(10) Pub. No.: US 2020/0099883 A1
(43) Pub. Date: Mar. 26, 2020

(54) TELEVISION FRAME ASSEMBLY

(71) Applicant: Christopher Buck, Saint Augustine, FL (US)

(72) Inventor: Christopher Buck, Saint Augustine, FL (US)

(21) Appl. No.: 16/137,749

(22) Filed: Sep. 21, 2018

(51) Int. Cl. H04N 5/64; H04R 1/02; H04N 5/225; H04N 5/63

(52) U.S. Cl. CPC H04N 5/642; H04R 1/028; H04R 2499/15; H04N 5/63; H04N 5/2257

(57) ABSTRACT

A television frame assembly that includes: a frame, where the frame includes an opening; a camera, where the camera is integrated into to frame; speakers on each side of the frame; a speaker relay adapted for connecting the speakers to an audio output; and a power unit to supply power to the frame assembly. The speakers include a tweeter, a mid-range and full range speaker. The power unit includes receptacles for other electronic devices and a connector for connecting to AC power.

### BACKGROUND OF THE INVENTION

### Field of Invention

The present invention relates to a frame assembly for placement around a conventional flat screen television.

### Description of Related Art

Flat screen televisions are commonly used in most households and essentially in most commercial settings. Many flat screen televisions have built-in speakers to allow for audio transmission. Otherwise on occasion individuals must connect audio speakers to the flat screen televisions to provide surround sound capability. As a result, it is normally typical to include external speakers to enhance the audio of the television programming. Some frames have been developed to enclose flat screen televisions to enhance their overall aesthetic design. Further aspects of modern television is the ability to engage through the Internet via the television through smart TVs or interconnections such as Apple TV or Amazon Fire Stick. As a result, it would be advantageous to have a frame that implements both audio enhancement, an aesthetic design and a web cam capabilities. The object of the present invention is to implement such features in a television frame.

### SUMMARY OF THE INVENTION

The present invention relates to a television frame assembly that includes: a frame, where the frame includes an opening; a camera, where the camera is integrated into to frame; speakers on each side of the frame; a speaker relay adapted for connecting the speakers to an audio output; and a power unit to supply power to the frame assembly. The speakers include a tweeter, a mid-range and full range speaker. The power unit includes receptacles for other electronic devices and a connector for connecting to AC power.

### BRIEF DESCRIPTION OF DRAWINGS

FIG. 1 depicts a front view of a television frame assembly according to the present invention.

FIG. 2 depicts a rear view of the television frame assembly according to the present invention.

### DETAILED DESCRIPTION

The present invention provides a flat screen frame system that is implemented to surround and support a flat screen TV in a wall mounted position. The frame system of the present invention includes a web cam integrated within the frame so users can engage and interact through the web cam. The frame further includes a plurality of speakers for audio play back associated with the television. These devices are connected to the TV and provide further features to enhance the viewing and interactive pleasure of the consumer.

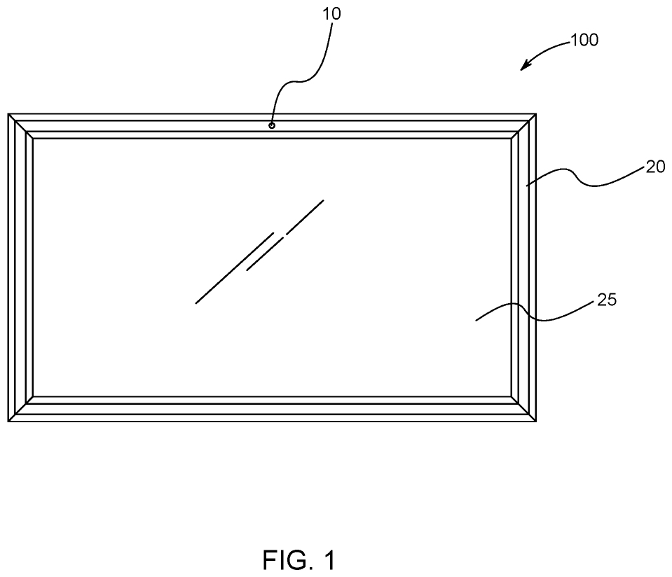

In reference to FIG. 1, a front view of a frame system 100 is depicted. This front view depicts a frame 20 with an opening 25 available to view a television screen. Preferably, a web camera 10 is also included in the frame 20. This web camera 10 is positioned at the top of the frame and shown in FIG. 1.

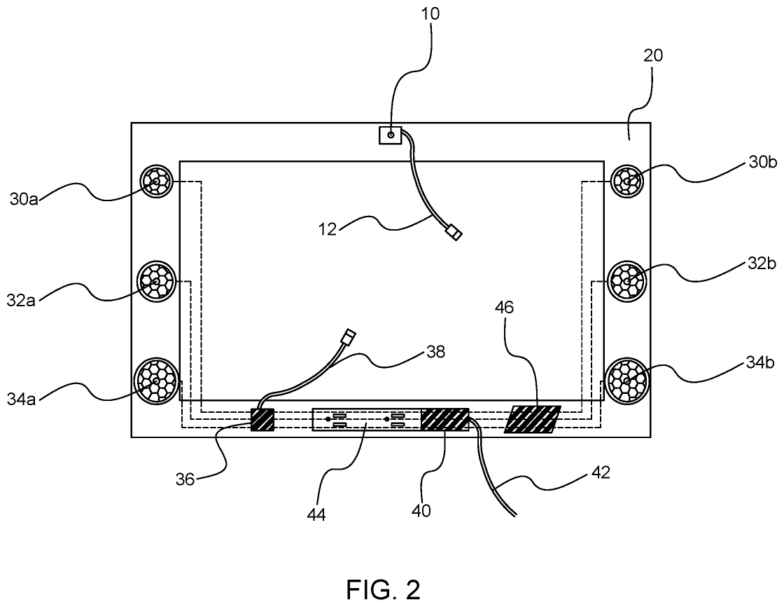

Other particular features of the frame 20 are shown in FIG. 2, which is a rear view of the frame 20 such as the speaker system provided. The frame 20 includes a series of speakers on each side of the frame. Tweeters 30a, 30b are provided on each side and are connected through speaker relay 36. The speaker relay 36 includes an audio connector 38 for insertion into the flat screen television and allows the transfer of sound through tweeters 30a, 30b. Other speakers provided include mid-range speakers 32a, 32b and main speakers 34a, 34b all which transfer through the speaker relay 36 and produces audio associated with the television. The speaker relay 36 also includes additional processors for Bluetooth and WiFi connectivity. Another control processor 46 relates to surround sound processing the speaker system. A Power Unit 40 is also shown in FIG. 2 that provides power to the speakers, web cam and components of the Frame 20. A further feature of the Frame 20 is an Outlet Strip 44 for an additional power outlet for other electronic accessories that may be part of the entertainment system.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A television frame assembly comprising:
a. a frame, where the frame includes an opening;
b. a camera, where the camera is integrated into to frame;
c. speakers on each side of the frame, where the speakers include a tweeter on each side of the frame and a mid-range speaker on each side of the frame;
d. a speaker relay adapted for connecting the speakers to an audio output; and
e. a power unit to supply power to the frame assembly.

2. (canceled)

3. The television frame assembly according to claim 1, where the power unit includes receptacles for other electronic devices.

4. The television frame assembly according to claim 1, where the power unit includes a connector.
